(19) United States
(12) Patent Application Publication
(10) Pub. No.: US 2008/0071744 A1
(43) Pub. Date: Mar. 20, 2008

(54) Method and System for Interactively Navigating Search Results

(76) Inventor: Elad Yom-Tov, Hoshaya (IL)

Correspondence Address: Stephen C. Kaufman;IBM CORPORATION, Intellectual Property Law Dept., P.O. Box 218, Yorktown Heights, NY, 10598, US

(21) Appl. No.: 11/532,571

(22) Filed: Sep. 18, 2006

(51) Int. Cl. G06F 17/30

(52) U.S. Cl. 707/3

(57) ABSTRACT

A method and system for interactively navigating search results is provided. The method includes searching a set of documents (502) by applying a query (501), wherein the query (501) is formed of at least one relevant term and retrieving a set of result documents (503). The method includes analyzing the set of result documents (503) to find candidate terms (505) which partition the set of result documents (503). The candidate terms (505) are presented for selection to reduce the number of result documents.

### FIELD OF THE INVENTION

This invention relates to the field of information retrieval. In particular, the invention relates to interactively navigating search results by selection of relevant terms.

### BACKGROUND OF THE INVENTION

Information retrieval systems in which documents are retrieved from a repository by a user submitting a query are used in many different fields. In addition to the most prevalent use of information retrieval systems for searching the internet, web sites, or intranets, information retrieval systems are also used in many other applications. For example, information retrieval systems are used in a support call-center in which a query based on a caller's problem is submitted to a repository of relevant support information. As another example, self-help systems may use an information retrieval system for retrieving answers from an answer repository in response to a user query.

In the context of the call-center example, currently call-center personnel try to help callers using their experience and/or databases containing solutions to known problems. There is an opportunity for the support person to obtain more information as to the problem by asking questions of the caller. However, finding the right answer depends on the support person's ability to ask the right questions. This is currently dependent upon the specific ability of the support person. It would be useful for a system to find the most informative question for the support person to ask, thereby speeding up the support process.

Currently, the state of the art in call-centers are those where on-line transcription of the call is provided. Using this transcription (or the session chat, in the case of on-line support), queries are formulated and submitted to a search engine which searches a repository of relevant support information. The top answers from these queries are presented to the support person in the hope that at least one of them solves the caller's problem.

Algorithms are available that generate a question in response to a query to attempt to refine the query. Such systems rely on a query log of queries previously entered by other uses. If a user enters a short query he will be asked if he meant one of a set of longer queries previously entered by other users. Such systems are common in Internet search applications.

Other methods are known for automatically refining a query by adding additional terms to the original query. The additional terms may, for example, be based on lexical affinities to original query terms. However, such refinement methods are aimed at being automatic and do not refer back to the user.

### SUMMARY OF THE INVENTION

It is an aim of the present invention to provide a method and system for navigating search results from a set of documents to arrive at a result set of a minimum number of documents. This is achieved by finding the best terms to partition a result set and user selection of the most relevant term.

According to a first aspect of the present invention there is provided a method for reducing search results, comprising: searching a set of documents by applying a query, wherein the query is formed of at least one relevant term; retrieving a set of result documents; analyzing the set of result documents to find candidate terms which partition the set of result documents; and presenting the candidate terms for selection.

According to a second aspect of the present invention there is provided a system for reducing search results, comprising: input means for a query, wherein the query is formed of at least one relevant term; a search system for retrieving a set of documents by applying the query to obtain a set of result documents; an analyzer for analyzing the set of result documents to find candidate terms which partition the set of result documents; and a user interface to present the candidate terms for selection.

According to a third aspect of the present invention there is provided a computer program product stored on a computer readable storage medium for navigating search results, comprising computer readable program code means for performing the steps of: searching a set of documents by applying a query, wherein the query is formed of at least one relevant term; retrieving a set of result documents; analyzing the set of result documents to find candidate terms which partition the set of result documents; and presenting the candidate terms for selection.

According to a fourth aspect of the present invention there is provided a method of providing a service to a customer over a network, the service comprising: searching a set of documents by applying a query, wherein the query is formed of at least one relevant term; retrieving a set of result documents; analyzing the set of result documents to find candidate terms which partition the set of result documents; and presenting the candidate terms for selection.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of an information retrieval system in accordance with the present invention;

FIG. 2 is a block diagram of a computer system in which the present invention may be implemented;

FIG. 3 is a flow diagram of a method in accordance with the present invention;

FIG. 4A is a flow diagram of a sub-method in accordance with an aspect of the present invention;

FIG. 4B is a table in accordance with the aspect of the present invention shown in FIG. 4A;

FIG. 5 is a schematic diagram illustrating a method in accordance with the present invention; and

FIG. 6 is a chart showing an example embodiment of results of a system in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

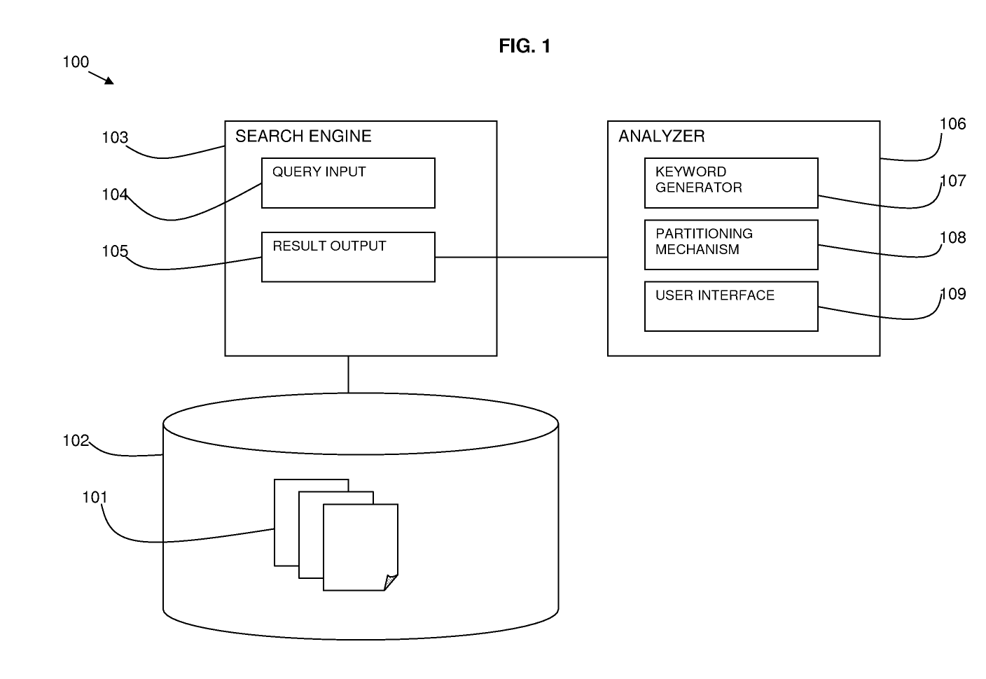

Referring to FIG. 1, an information retrieval system 100 is provided for retrieving documents 101 from a repository 102. The repository 102 may take the form of any collection of documents. For example, the repository 102 may be a database, a plurality of databases, the internet, a web site, an intranet, etc. The documents 101 may be text items in the form of solutions, questions, instructions, etc. The documents 101 may be web pages, text documents, etc.

A search engine 103 retrieves documents from the repository 102 and has an input means 104 for a user to input a query and an output means 105 for output of a set of document results. The search engine 103 may be directly connected to the repository 102 or connected via a network.

An analyzer 106 is provided for processing the results of the search engine 103. The analyzer 106 may be integrated with the search engine 103 or connected to the search engine 103 directly or via a network. The analyzer 106 includes a keyword generating mechanism 107 for generating candidate keywords from a set of document results output by the search engine 103 and a means 108 for determining the candidate keywords that best partition the set of document results. The analyzer 106 includes a user interface 109 for user input to the analyzer 106. The user interface 109 may also include query input means for submitting the query to the search engine 103.

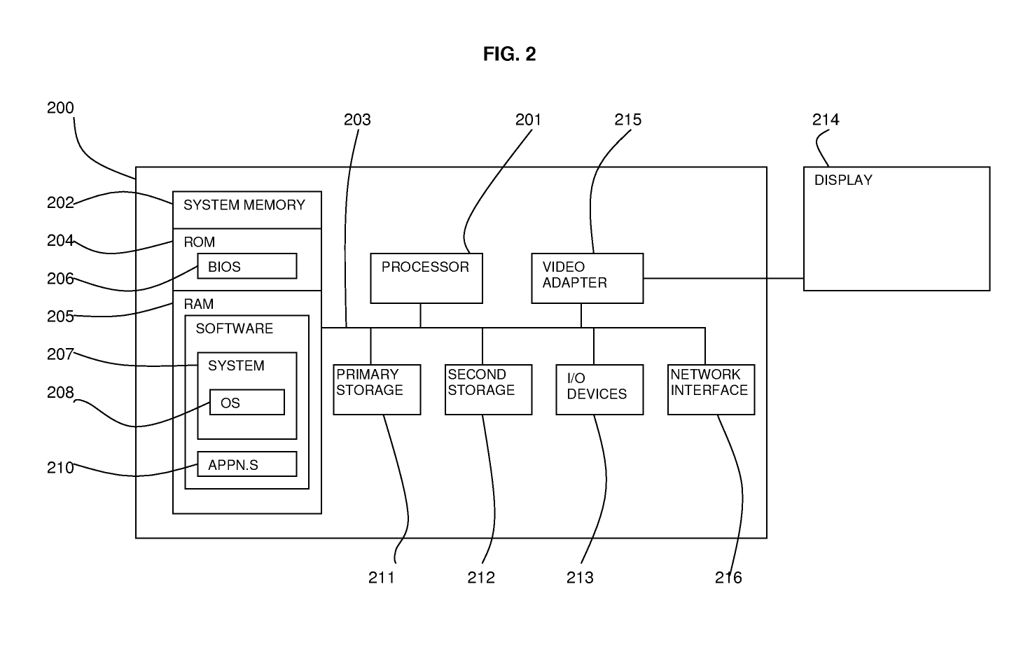

Referring to FIG. 2, an exemplary system for implementing the analyzer 106 includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

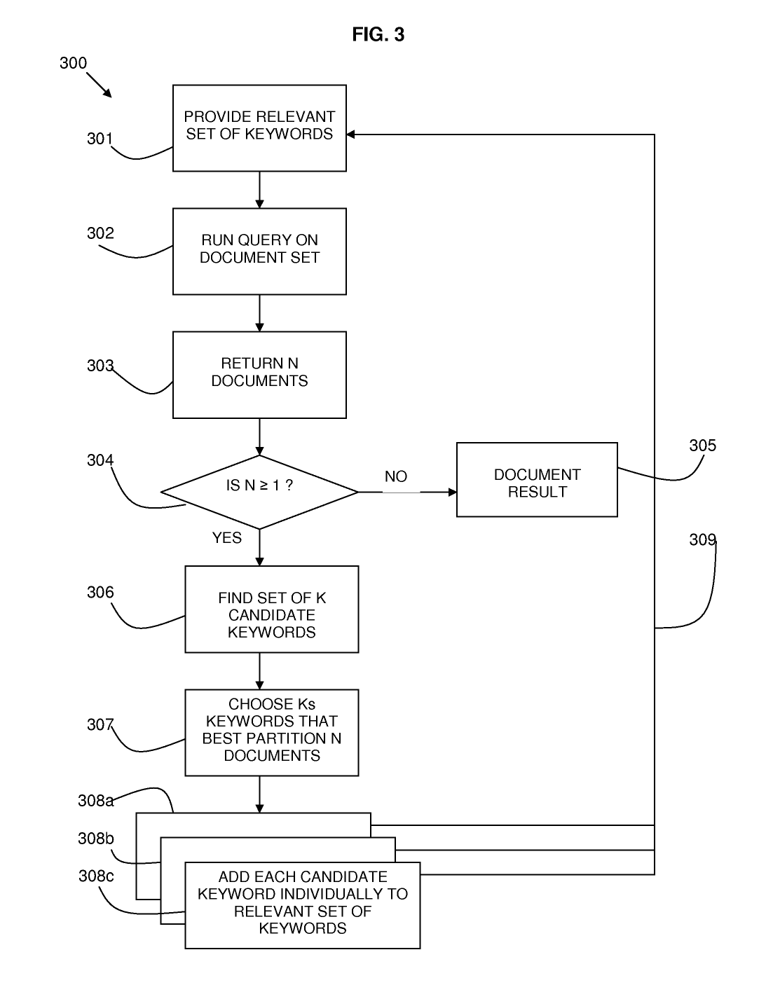

An embodiment of the method of reducing search results is now described with reference to FIG. 3 which shows a flow diagram 300 of the method steps.

The method starts with a set of “seed” words 301. This set is referred to as the “relevant set of keywords”. A query is run 302 with the relevant set of keywords on a set of documents such as those in the repository 102 of FIG. 1. All documents or documents of the highest ranking which contain the query words are returned 303 as a set of document results.

In general the system can use keywords, phrases, or sets of keywords which commonly appear together. For clarity we refer to keywords in the following, but other embodiments could use any of these options or a combination of them.

It is determined 304 if the number of documents in the set of document results is greater than a minimum number of documents. The minimum number of documents may be pre-defined based on the aim of the reductions of the search results. For example, in some circumstances the aim may be to reduce the results to one document. If the number of documents is not greater than the minimum number, the method can stop as a minimum number of documents has been retrieved 305. However, if the number is greater than the minimum number, the method proceeds.

The next step is to find a set of K candidate keywords 306 from the set of document results. From the set of K candidate keywords found in step 306, a sub-set of Ks keywords are chosen 307 that best partition the set of document results for the query.

At this stage, a user may select the most relevant keyword from the sub-set of Ks keywords and the search result reduction will branch to this keyword. Alternatively, each of the Ks keywords can be used separately.

Each candidate keyword may be added 308a-d to the original relevant set of keywords and, for each new set, the method may loop 309 to perform steps 302-307. As noted above, it is also possible to use just one keyword chosen by the user and only add this keyword to the original relevant set. The method steps 302-307 may be performed separately for each of the Ks keywords, until the results set at step 303 contains a minimum number of documents. Thus a minimum number of documents 305 may be achieved for each branch of the keywords Ks, or only for the path of keywords chosen by the user.

When a keyword is added to the search term and step 302 is repeated, it can be run on either the entire set of documents or, in an alternative embodiment, only on the set of documents contain the previous set of search terms. In practice the second embodiment is usually preferred because it is faster to execute.

In step 306 a set of K candidate keywords from the set of document results is generated. In one described embodiment, these keywords are those that best separate the set of top N documents retrieved by the query from the set of M lower-ranked documents, with the additional constraint that the keywords appear in the result documents near (for example, within 5 words) of the original query terms.

This is the method described in Carmel, D., Farchi, E., Petruschka, Y., and Soffer, A. 2002. Automatic query refinement using lexical affinities with maximal information gain. In Proceedings of the 25th Annual international ACM SIGIR Conference on Research and Development in information Retrieval (Tampere, Finland, Aug. 11-15, 2002). SIGIR '02. ACM Press, New York, N.Y., 283-290. DOI=http://doi.acm.org/10.1145/564376.564427. This document is incorporated herein by reference.

In this document an automatic refinement technique is described which uses lexical affinities (LA) as terms for refinement of a query. Lexical affinities are pairs of closely related words which contain one of the original query terms. Adding these terms to the query is equivalent to re-ranking search results. The document describes selecting the most informative LAs for refinement that best separate relevant documents from irrelevant documents in the set of results. The information gain of candidate LAs is determined using unsupervised estimation that is based on the scoring function of the search engine.

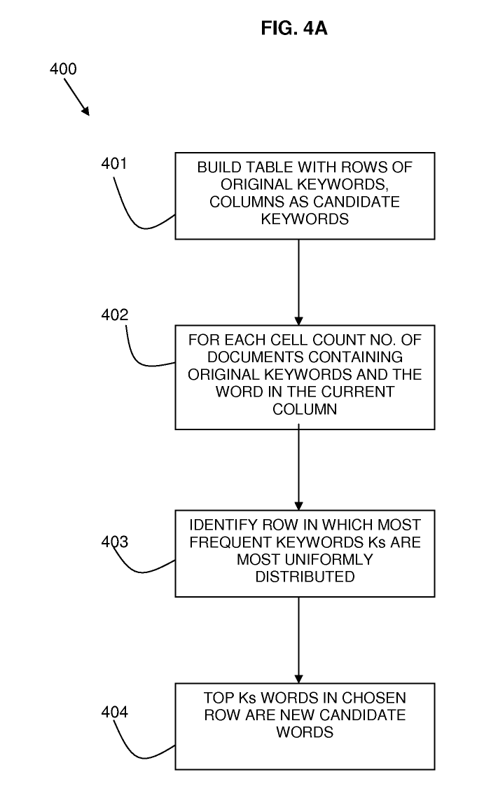

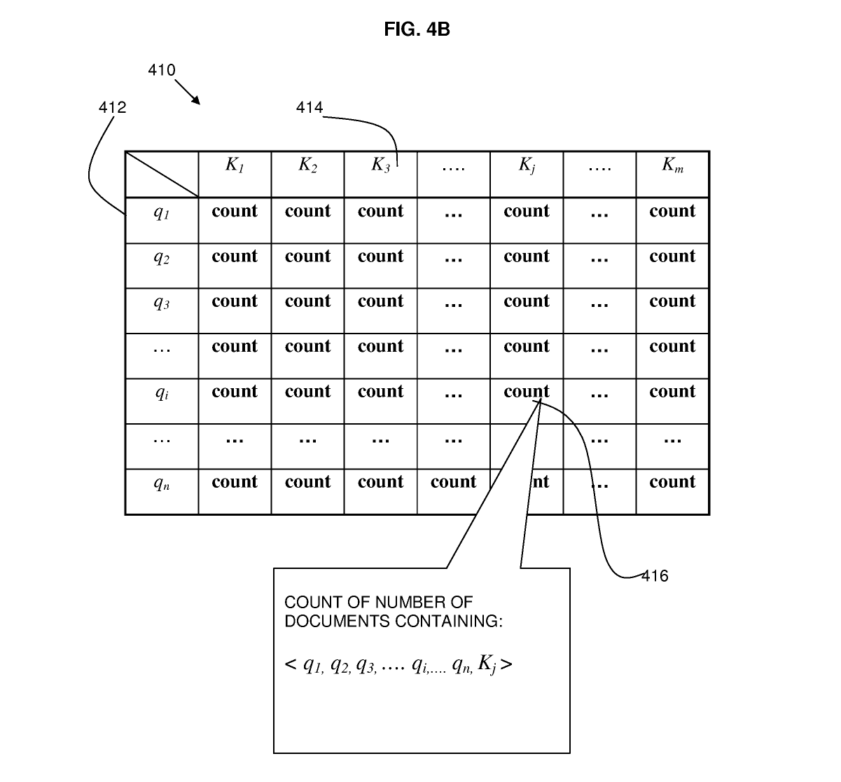

One embodiment of the step 307 of choosing the sub-set of Ks keywords that best partition the results set of document results is described further with reference to FIG. 4A. FIG. 4A is a flow diagram 400 of the sub-method of step 307 of FIG. 3.

This method builds a table 401 whose rows are the original relevant keywords and the columns are the candidate keywords. In each cell of the table, a count is entered 402 of the number of documents that contain the original relevant keywords and the word in the current column.

Next, the row in which the most frequent Ks keywords are most uniformly distributed is identified 403. This is done in the following manner. In each row, the most frequent Ks words are identified. The count for all other keywords is set to zero. The row is then normalized by dividing each cell by the sum of the cells in the row. The row is then given a score of how uniformly distributed the top Ks terms are using the Chi square test. The row with the lowest score (corresponding to the most uniform distribution) is chosen, and the top Ks new words in it are used as candidate words 404.

FIG. 4B shows a table in accordance with the method of FIG. 4A. The table 410 has rows 412 for each of the original relevant keywords {q₁, q₂, . . . qᵢ, . . . qₙ}, and columns 414 for each of the candidate keywords {K₁, K₂, . . . Kⱼ, . . . Kₘ}. A cell 416 (qᵢ, Kⱼ) has a count of the number of documents containing (q₁, q₂, . . . 2qᵢ, . . . q_{n,}, Kⱼ),

In an alternative embodiment, the steps 306 and 307 of FIG. 3 of selecting keywords may be carried out by other methods of query expansion and candidate selection.

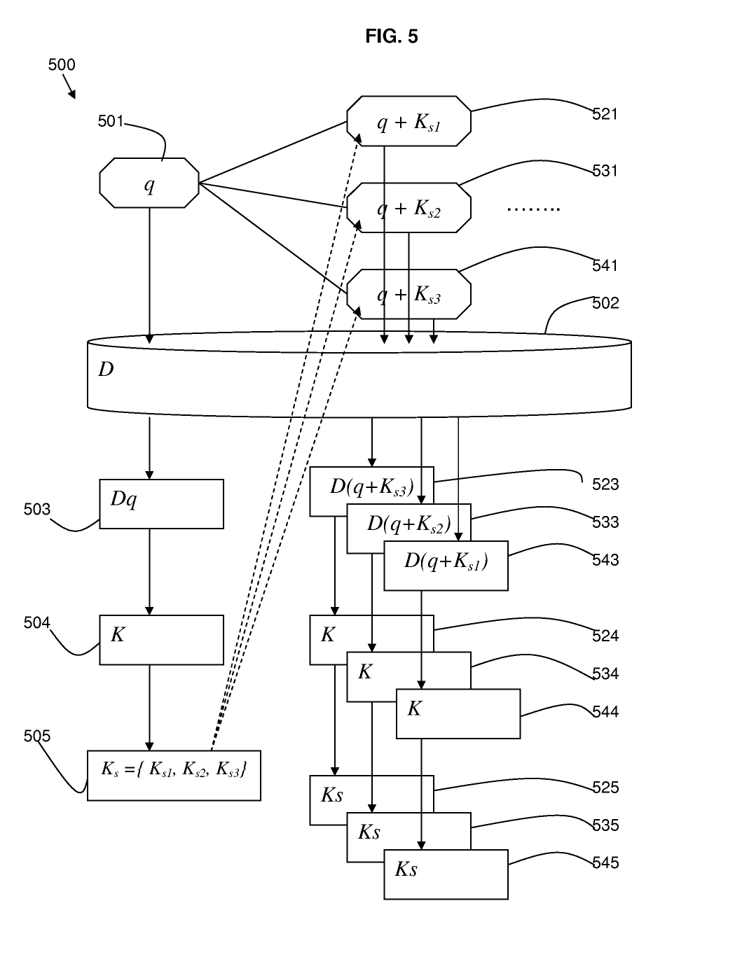

Referring to FIG. 5, a schematic diagram 500 shows a query q 501 submitted to a set of document D 502 to obtain a set of document results for the query D_{d} 503. Candidate keywords K 504 with subset Ks 505 are obtained. For each candidate keyword Ks a new query (q+Ksᵢ) 521, 531, 541 can be generated and applied to the set of documents D 502. In each branch, a set of document results for the query is obtained D_{(q+Ksi)} 523, 533, 543 from which new candidate keywords K 524, 534, 544 and Ks 525, 535, 545 can be obtained. This repeats for each branch until there is a minimum number of keywords Ks at the end of a branch.

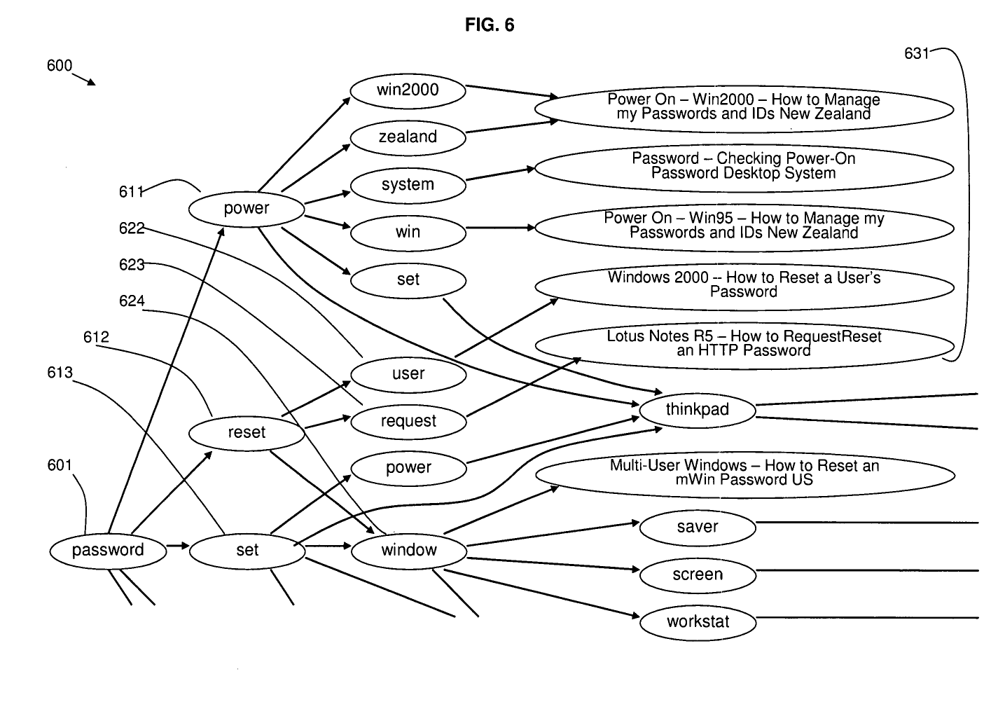

An example of results of the algorithm is shown in FIG. 6, based on a set of questions and answers in a help scenario.

The illustrated graph 600 of FIG. 6 is a partial flowchart automatically generated with the word “password” 601 as the root. That is, this is the flowchart that a user (or a System Administrator) with problems with a password would use. Candidate words are shown as child nodes of the root word “password” 601 with solution documents at the leaf nodes.

Going from left to right, starting with the node marked “password” 601, the next question that will be applied is whether the problem is related to power (power-on password) 611, reset 612, set 613, etc. regarding passwords. If the user selects, for example, “reset” 612, the next question will be if the problem is related to user 622, request 623, or windows 624. If the user then chooses request 623, he will be directed to a solution 631 on how to request reset on Notes 5 passwords. The size of the graph 600 is limited for display purposes.

The described method and system have two modes of operation. A first mode is an on-line mode in which at each iteration, the user selects the most relevant keyword. The search results are navigated during the interaction with the user. A second mode is an off-line mode in which a complete decision tree is created and stored which may be used by different users. In the second mode, the decision tree may be displayed to the user, for example, as a problem and solution flow chart, or may be hidden with only the relevant branches displayed in accordance with the user's keyword selection at each branch.

In one embodiment, the described method and system may be used in a support center application. Support centers may use automatic transcription of telephone conversations to obtain text on which to base an initial query to a repository of solutions. Queries can also be generated from text to voice system, instance messaging or online chat interfaces.

When the top documents from the repository are retrieved, they will not be presented to the support person. Instead, they will be analyzed to find which terms best partition the set of documents. The system will then ask the support person to ask the caller about these terms, so as to focus on the answer as quickly as possible. This is akin to the process of active learning, albeit here the “learner” is the support person.

For example, suppose that a user calls and says that his password does not work. Searching for a query with “password” will return documents about passwords in many systems. The proposed system might find that the best terms to partition the documents are “Windows”, “AFS”, and “Other”. It will therefore propose that the support person ask “Do you mean your Windows password, AFS password, or is it another system?”

The full graph need not be displayed to the user. Instead, at each instance only the current question is displayed. Using this process will greatly speed the support process.

Another application of the described method and system is in generating questions in self-help systems of in flow-charts for problem determination. Solutions may be provided in a repository of previous problems and solutions. A starting point to the algorithm is in the form of a query, and at each stage the algorithm will run the query, identify possible next queries for selection by the user, etc. In this way the problem is refined to a more specific problem and the number of solutions is reduced until the most relevant solution or solutions are found.

The described method can be applied to many different environments in which a user is available to select terms for refinement of a search and thereby narrowing the number of possible results.

An analyzer for providing refinement as described either alone or as part of a search engine may be provided as a service to a customer over a network.

In another embodiment, the system can analyze a database of questions and answers to produce a flow chart for fixing problems in a hardware or a software system, for use by technicians.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for navigating search results, comprising:
searching a set of documents by applying a query, wherein the query is formed of at least one relevant term;
retrieving a set of result documents;
analyzing the set of result documents to find candidate terms which partition the set of result documents; and
presenting the candidate terms for selection.

2. A method as claimed in claim 1, wherein analyzing the set of result documents to find candidate terms includes determining relevant terms from the set of result documents, and determining the terms which best partition the set of result documents.

3. A method as claimed in claim 2, wherein determining relevant terms in the set of result documents finds terms that best separates a set of N top ranked documents from a set of M lower-ranked documents.

4. A method as claimed in claim 2, wherein determining relevant terms in the set of result documents finds terms within a predefined distance from a query term.

5. A method as claimed in claim 1, wherein analyzing the set of result documents to find candidate terms which partition the set of result documents includes:
compiling a count of occurrences of the query terms and each candidate term in the set of document results and analyzing the count.

6. A method as claimed in claim 1, wherein a selected candidate term is added to the query and the method steps are repeated.

7. A method as claimed in claim 6, wherein the method is repeated until a predefined minimum number of documents are retrieved in the set of result documents.

8. A method as claimed in claim 1, including providing a decision tree with a query as the root node and branches of candidate terms for selection.

9. A method as claimed in claim 1, wherein a set of documents is analyzed to create a partitioned set, including applying an empty query and finding candidate terms which partition the whole set of documents.

10. A system for reducing search results, comprising:
input means for a query, wherein the query is formed of at least one relevant term;
a search system for retrieving a set of documents by applying the query to obtain a set of result documents;
an analyzer for analyzing the set of result documents to find candidate terms which partition the set of result documents; and
a user interface to present the candidate terms for selection.

11. A system as claimed in claim 10, wherein the analyzer includes means for determining relevant terms from the set of result documents, and means for determining the terms which best partition the set of result documents to provide candidate terms.

12. A system as claimed in claim 11, wherein the means for determining relevant terms from the set of result documents finds candidate terms that best separates a set of N top ranked documents from a set of M lower-ranked documents.

13. A system as claimed in claim 11, wherein the means for determining relevant terms from the set of result documents finds terms within a predefined distance from a query term.

14. A system as claimed in claim 10, wherein analyzer includes:
a table for compiling a count of occurrences of the query terms and each candidate term in the set of document results and analyzing the count.

15. A system as claimed in claim 10, wherein the user interface includes a decision tree with a query as the root node and branches of candidate terms.

16. A system as claimed in claim 10, wherein the analyzer is integral to a search engine.

17. A system as claimed in claim 10, wherein the system is a problem and solution system and the query identifies the problem and the set of documents is a set of solution documents.

18. A system as claimed in claim 17, wherein the query is obtained from a transcript of a user's call, or an online text input.

19. A computer program product stored on a computer readable storage medium for navigating search results, comprising computer readable program code means for performing the steps of:
searching a set of documents by applying a query, wherein the query is formed of at least one relevant term;
retrieving a set of result documents;
analyzing the set of result documents to find candidate terms which partition the set of result documents; and
presenting the candidate terms for selection.

20. A method of providing a service to a customer over a network, the service comprising:
searching a set of documents by applying a query, wherein the query is formed of at least one relevant term;
retrieving a set of result documents;
analyzing the set of result documents to find candidate terms which partition the set of result documents; and
presenting the candidate terms for selection.
